(19) United States
(12) Patent Application Publication
(10) Pub. No.: US 2025/0275881 A1
(43) Pub. Date: Sep. 4, 2025

(54) FLUID-POWERED ARTIFICIAL MUSCLE OR MUSCLES FOR COMPRESSION APPLICATIONS

(71) Applicants: Jordan Andrew SAVAGE, Toronto (CA); Run Ze GAO, Kitchener (CA); Carolyn Liqing REN, Waterloo (CA)

(72) Inventors: Jordan Andrew SAVAGE, Toronto (CA); Run Ze GAO, Kitchener (CA); Carolyn Liqing REN, Waterloo (CA)

(21) Appl. No.: 19/065,548

(22) Filed: Feb. 27, 2025

Related U.S. Application Data
(60) Provisional application No. 63/559,304, filed on Feb. 29, 2024.

(51) Int. Cl. A61H 9/00

(52) U.S. Cl. CPC A61H 9/0078; A61H 2201/5053

(57) ABSTRACT

A compression actuator has a fluid-powered artificial muscle (FPAM) set of at least one FPAM. The compression actuator has a circular or helical shape and is resilient. A compression garment includes the compression therapy device and a garment fabric coupled with the compression therapy device. The compression garment may be a sleeve or glove, or a combination thereof. A compression therapy method includes enveloping a body part of a patient with the compression actuator set of the compression therapy device, and inflating the compression actuator set to apply compression to the body part. A method for making an FPAM having a circular or helical shape includes wrapping a precursor FPAM having a linear shape around a mandrel having the circular or helical shape to form an assembly, treating the assembly to generate a treated FPAM having the circular or helical shape, and removing the treated FPAM from the mandrel.

### CROSS-REFERENCE TO RELATED APPLICATIONS

This application claims priority from U.S. Provisional Application No. 63/559,304, filed on Feb. 29, 2024, the entirety of which is hereby incorporated by reference herein.

### FIELD

The present disclosure relates to rehabilitative or manual therapy, including, for example, sports therapy, physiotherapy, medical compression, and massage.

### BACKGROUND

Fluid-actuated systems are commonly used for the treatment of circulatory disorders such as lymphedema, deep vein thrombosis (DVT), and venous leg ulcers. In addition, they can be used for massage therapy, post-surgery recovery treatments, pre-activity preparation for physical activity, and post-activity muscle recovery for sports or other physical activity.

For example, United States Patent Application Publication No. 2020/0237607 A1 discloses a pneumatic compression garment wherein there are independently controlled ring-shaped elastomer chambers encircling the limb. United States Patent Publication No. 8361002 B2 discloses a pneumatic device designed to aid in joint trauma recovery that uses inflatable bladder straps to clamp a user's limb to an orthotic device.

In particular, some previous techniques employ fluid-powered artificial muscles (FPAMs). An early teaching of FPAMs is United States Patent Publication No. 2844126 A, which teaches a fluid actuated motor system and stroking device used to hoist a load. Later, United States Patent Publication No. 8900168 B2 teaches a body surface compression device using a pneumatic actuated artificial muscle in combination with a belt placed around a body part, where both artificial muscle shortening and pneumatic expansion are used for compression.

Despite any utility provided by the above-referenced or other previously-known devices and techniques, there remains an ongoing need for additional and better devices and techniques useful for rehabilitative or manual therapy.

### BRIEF DESCRIPTIONS OF THE DRAWINGS

Embodiments will now be described, by way of example only, with reference to the attached Figures.

FIG. 1 shows a block diagram of a compression therapy system.

FIG. 2A shows a side view of a first FPAM, and FIG. 2B shows a transverse cross-sectional view corresponding to FIG. 2A.

FIG. 3A shows a side view of a second FPAM, and FIG. 3B shows a transverse cross-sectional view corresponding to FIG. 3A.

FIG. 4A shows a side view of a third FPAM, and FIG. 4B shows a longitudinal cross-sectional view corresponding to FIG. 4A.

FIGS. 5A, 5B & 5C show perspective views illustrating formation of a rectilinear FPAM.

FIGS. 6A & 6B show perspective views of an FPAM and mandrel illustrating formation of a helical FPAM.

FIGS. 7A & 7B show transverse cross-sectional views of a circular FPAM and object illustrating the application of constrictive force on the object by the FPAM caused by inflation thereof.

FIGS. 8A & 8B show perspective views of a first compression therapy device applied to a body part, namely a forearm.

FIG. 9 shows a side view of a second compression therapy device applied to a body part, namely an arm.

FIG. 10 shows a side view of a third compression therapy device applied to a body part, namely a hand.

FIG. 11 shows a side view of a fourth compression therapy device which is a combination of the second and third compression therapy devices of FIGS. 9 & 10, applied to a body part, namely an arm and hand.

FIGS. 12A & 12B show perspective and cross-sectional views of a first constriction device. FIGS. 12C & 12D show perspective views illustrating coupling of the first constriction device with a bladder.

FIGS. 13A & 13B show perspective views illustrating formation of a constriction in a bladder using a crimping method.

FIGS. 14A & 14B show perspective views illustrating formation of a constriction in a bladder using a second constriction device.

FIG. 15 shows a flowchart of a method for making an FPAM having a circular or helical shape.

FIG. 16 shows a flowchart of a compression therapy method using a compression therapy device.

It is to be understood that the accompanying drawings are used for illustrating the principles of the embodiments and exemplifications of the subject-matter discussed herein. Hence the drawings are illustrated for simplicity and clarity, and not necessarily drawn to scale and are not intended to be limiting in scope. Reference characters/numbers are used to depict the elements of the subject-matter discussed that are also shown in the drawings. The same reference characters/numbers are given to a corresponding component or components of the same or similar nature, which may be depicted in multiple drawings for clarity. It should be noted that features depicted by one drawing may be used in conjunction with or within other drawings or substitute features of other drawings. It should further be noted that common and well-understood elements for creating a commercially viable version of the embodiments discussed herein are often not depicted to facilitate a better view of the principles and elements of the subject-matter discussed herein. Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompassed by the corresponding description.

### DESCRIPTION

### Overview

The disclosed subject-matter concerns the improved and advantageous use of soft robotics in the fields of sports therapy, medical compression, and massage, among other applications. In particular, one or more fluid-powered artificial muscles (FPAMs) may be wrapped around an object, appendage, and/or any anatomical part of a body, to provide constriction and/or compression upon inflation/pressurization.

Typical FPAMs are commonly used as linear actuators, and they are often known for their flexibility during actuation, cost efficacy, and high force output-to-weight ratio. FPAMs are often powered by gas, although liquid-based actuators are also known. Most FPAMs rely on an inflatable inner bladder surrounded by a sheath of fibers that wrap helically around the bladder. Inflation causes the radius of the helix to increase, and as a result, the length of the helix must decrease, resulting in longitudinal contraction. Some FPAMs incorporate the fiber helix into the bladder as a composite. Most but not all bladders are made of an elastomer.

The design and manufacturing methods disclosed herein may be used to make FPAMs that are long enough to coil around any size of body part, and which enables the FPAM/FPAMs to inflate in a pre-determined pattern. In particular, the design and manufacturing methods may involve heat treatment of the FPAM to preconfigure its resting geometry so as to make it more suitable for the intended use.

The compression therapy device including one or more FPAMs disclosed herein can be coiled in a circular or helical fashion around the object, appendage, and/or any anatomical part of a body, and/or can be made into a closed-loop ring shape and/or otherwise encircled. Any of these methods can be used to grip or apply compressive pressure to objects, appendages, and/or any anatomical part of a body. The FPAM may consist of any fiber-reinforced, fiber-sheathed pneumatic, and/or fluidic artificial muscle, and/or any combination thereof. In particular, the respective bladders of multiple FPAMs may be fluidly coupled end-to-end and/or a single bladder may be sheathed by at least one expansible woven mesh using flexible, semi-rigid and/or rigid tubing that may be smooth and straight. The FPAM may be used in a compressive garment designed to treat medical ailments including but not limited to DVT, lymphedema, and venous ulcers, and/or for use in physiotherapy and massage applications. The garment may include either at least one coiled FPAM and/or any number of closed loop FPAMs encircling the treated appendage, and/or any anatomical part of a body.

### Glossary

In the present disclosure, the following terms and expressions are intended to have the corresponding meanings.

“FPAM” or “Fluid-Powered Artificial Muscle” includes a mechanized apparatus employing fluid-based systems, including but not limited to pneumatic or hydraulic mechanisms, operable to replicate or simulate the biomechanical function of natural musculature. They may consist of compliant materials operable to undergo expansion or contraction in response to change in fluid pressure and/or flow, thereby facilitating mechanical force and motion.

“Fluid” includes any type or any mixture of fluid, such as gas, liquid, specialty fluid, magnetic fluid, electrical-driven fluid, Newtonian or non-Newtonian fluid, under any appropriate condition, which may include but is not limited to temperature, pressure, compressible and/or incompressible flow, laminar and/or turbulent flow, subsonic, and/or supersonic speed.

“Inflated” and “pressurized” may be used interchangeably unless explicitly stated otherwise.

“Deflated” and “depressurized” may be used interchangeably unless explicitly stated otherwise.

“Actuator” includes an FPAM including its components including but not limited to a sheath, inlet, optional outlet, and bladder.

“Bladder” includes an inflatable chamber of an actuator.

“Sheath” includes a radially extensible, either woven or non-woven, fiber network. The sheath fibers may be woven in a double helix formation, may be made of natural or synthetic fibers, and may be made of any material including elastic materials.

“Microfluidic constriction” means a constriction having a cross-sectional characteristic length including but not limited to from about 10 mm to about 0.1 μm, although other dimensions are possible and contemplated.

“Resilient”, with respect to an object, means tending to rebound to its original shape or position after bending, stretching, compression, or other deformation, by at least a predetermined relative degree, when force or pressure causing the bending, stretching, compression, or other deformation is relaxed, within a predetermined ranges of parameters including at least a relative degree of the bending, stretching, compression, or other deformation. In particular, when used with respect to an FPAM or actuator, “resilient” means that the FPAM or actuator when inflated tends to rebound to its original shape or position when the inflation is relaxed or removed.

“Envelop”, “enveloping”, and “enveloped”, and similar terms when used in connection with the relationship between embodiments of the compression therapy device and body part disclosed herein, and between embodiments of the FPAM sheath and bladder disclosed herein, include, as the case requires, cladding-with, slipping-on, wrapping-around, or any other similar action or condition whereby the compression therapy device or sheath is brought into close, conforming contact with the body part or bladder, respectively, without necessarily entirely covering or encasing the body part or bladder, while nevertheless permitting this possibility in some cases.

“Sleeve” refers to a garment that covers or envelops any body part.

### Compression Therapy System

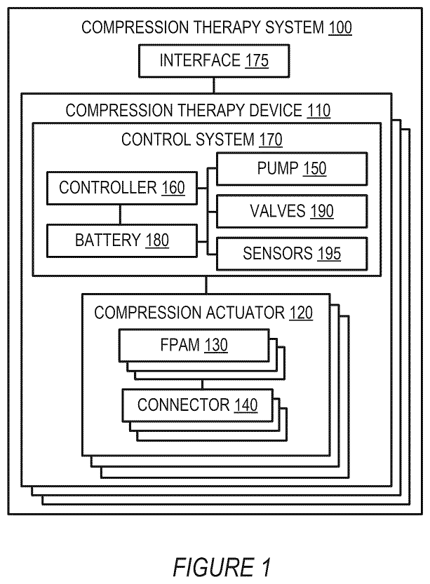

Compression therapy devices including FPAMs disclosed herein can be used in any suitable combination or arrangement given a particular application, including any particular therapeutic requirement or situation. Thus, FIG. 1 shows a block diagram of a compression therapy system 100 having at least one compression therapy device 110, which may be any compression therapy device disclosed herein. The compression therapy device 110 has at least one compression actuator 120, which may be any compression actuator disclosed herein. The compression actuator 120 has at least one FPAM 130, which may be any FPAM disclosed herein. The compression actuator 120 further has at least one connector 140, which may be any connector disclosed herein. In particular, the at least one connector 140 may include at least one external connector, which may be an inlet connector for fluidly connecting the at least one compression actuator 120 to any source of pressurized fluid, and may also include at least one internal fluid connector connecting multiple FPAMs 130 when present.

The at least one compression therapy device 110 may also have a pump 150 as the source of pressurized fluid, or the pump 150 may be external to the at least one compression therapy device 110 and fluidly coupled to it. In different embodiments, the pump 150 may be a manual pump, such as a hand pump, a pump powered by motion of one or more body parts, or may be powered by an energy source. In any event, the pump 150 may be any pump or source of pressurized fluid disclosed herein, and all alternatives operable with the subject-matter disclosed herein are possible and contemplated. The at least one compression therapy device 110 may further have a controller 160 operable to control the pump 150 to control supply of pressurized fluid to the at least one compression actuator 120 and therefore to the at least one FPAM 130. In any event, the controller 160 may be any controller disclosed herein. The at least one compression therapy device 110 may further have a battery 180 or other source of power to power the controller 160, and optionally also the pump 150. The at least one compression therapy device 110 may also have valves 190, which may include one or more valves, operable by the controller 160, to control supply of pressurized fluid to or between the at least one compression actuator 120.

When present, the controller 160, the pump 150, the battery 180, and the valves 190 may be separate components, or may together constitute a control system 170. The control system 170 may be any control system disclosed herein. The compression therapy system 100 may further include an interface 175 communicatively coupled with the controller 160 and operable to control the controller 160 to operate the at least one compression therapy device 110. The interface 175 may be communicatively coupled by any suitable means with the controller 160, which may be a wired or wireless connection, which may be Bluetooth™ or Wi-Fi™. Further alternatives are possible and contemplated. The control system 170 may function to control the at least one compression actuator 120 to pressurize/inflate and/or depressurize/deflate the at least one FPAM 130. The control system 170 may further comprise any additional or different components in order to perform the functionality described herein, and in different embodiments may further comprise a microcontroller, a motor controller, button(s) and/or switches and/or any combination thereof. The control system 170 may also have Bluetooth™, Wi-Fi™, and/or other wired or wireless connectivity for communication with the interface 175. The control system 170 may have or use feedback from sensors 195, such as, but not limited to, flow sensors, fluid pressure sensors, compression pressure sensors, and/or temperature sensors, one or more of which may be coupled with or form a part of one or more of the control system 170, may be coupled with or form a part of at least one compression actuator 120.

Embodiments of the compression therapy device may constitute a compressive garment operable to perform compressive therapy on a body part of a person. Any type and kind of compressive garments are possible and contemplated. For example, in different embodiments the compressive garment may be a glove or a sleeve. In particular, embodiments of the compression actuator may be incorporated in or otherwise form a part of such a compressive garment. The FPAM or set of FPAMs of the compression actuator, as the case may be, may be secured at each end thereof, either fully or partially, by constraining the ends to the geometry of the garment. Such constraining connection to the garment may be either permanent or temporary. The FPAM or set of FPAMs of the compression actuator, as the case may be, may be placed between, under, and/or above any number of layers of fabric of the garment, where the fabric may comprise but is not limited to a skin contact layer, a strain limiting layer, and/or an insulating layer. Components of the garment may additionally apply a passive continuous compression to the body part due to natural elasticity or manual tightening of the garment.

### Example FPAMs

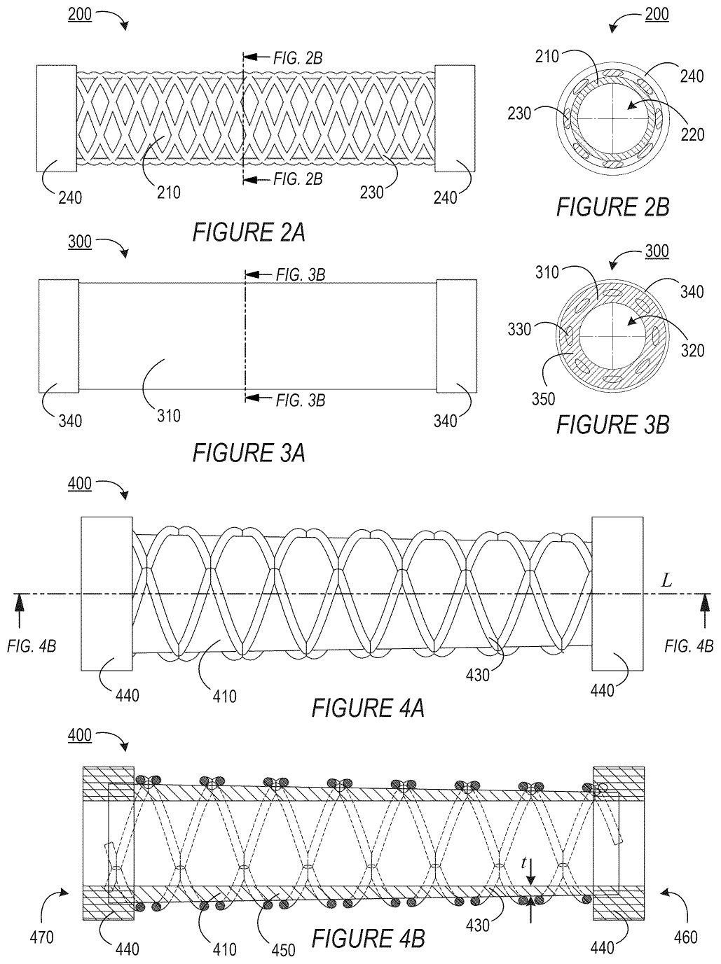

FIGS. 2A to 4B show non-limiting examples of FPAMs useful with embodiments of the compression therapy device. Although the FPAMs are shown to be straight, when the compression actuator is applied to a body part, it has a circular or helical shape, and thus the single FPAM, or the set of FPAMs, as the case may be, also have the circular or helical shape. Methods for producing the compression actuator having the circular or helical shape are described in the next section. In addition, other FPAMs are possible and contemplated. Embodiments of the FPAM may be formed of any suitable material or materials, and in some embodiments are formed of elastomeric materials.

FIGS. 2A & 2B show an FPAM 200 having a bladder 210 defining a pressurization chamber 220, a sheath 230 enveloping the bladder 210, and connectors 240 fluidly coupled with the bladder 210.

FIGS. 3A & 3B show an FPAM 300 having a bladder 310 defining a pressurization chamber 320, a sheath 330, a bladder 310, and connectors 340 fluidly coupled with the bladder 210. The FPAM 300 is different from FPAM 200 in that it has a composite sheath-bladder structure, where the sheath 330 is embedded within a wall 350 of the bladder 310, as opposed to enveloping the bladder 310, as is the case with the sheath 230 and bladder 210 of FPAM 200.

FIGS. 4A & 4B show an FPAM 400 having a bladder 410 defining a pressurization chamber 420, a sheath 430 enveloping the bladder 410, and connectors 440 fluidly coupled with the bladder 410. The FPAM 400 is substantially similar to the FPAM 200, except in that a thickness t of a wall 450 of the bladder 410 varies along a longitudinal axis L of the bladder 410, or equivalently the FPAM 400, so as to increase from a first end 460 of the FPAM 400 to a second end 470 of the FPAM 400. The wall thickness variation may be continuous or include stepwise increments. Such a configuration may enable sequential inflation of the FPAM 400, and thus a compression actuator having the FPAM 400, from the first end 460 to the second end 470 given an increasing pressure within the pressurization chamber 420. Alternatively, or additionally, a material of the wall 450 of the bladder 410 may vary along the longitudinal axis L such that at least one material property, which may include elasticity, likewise varies along the longitudinal axis L, so as similarly to enable sequential inflation of the FPAM 400, and thus a compression actuator having the FPAM 400, from the first end 460 to the second end 470 given an increasing pressure within the pressurization chamber 420. Similarly, the material property variation may be smooth or in stepwise increments. In particular, such a configuration may enable sequential inflation of the FPAM 400 without the need for microfluidics, multiple solenoids, or other active structures.

In different embodiments, the sheath material fibers may be a continuous helix, discontinuous helix, and/or may be parallel with the longitudinal axis of the FPAM, and/or any combination thereof. Fibers that are parallel with the longitudinal axis of the FPAM may be embedded in the bladder. The mechanism of contraction caused by these fibers may be fundamentally the same as the helical fiber mechanism. Upon inflation/pressurization, the fiber may curve outwards and, given that its length cannot change substantially, the fiber may generate a contraction force along the longitudinal axis of the FPAM from the outward expansion of the sheath.

### Making FPAMs and Circular/Helical FPAMs

As described above, embodiments of the compression therapy device include at least one compression actuator, which includes at least one FPAM having a generally circular or helical shape.

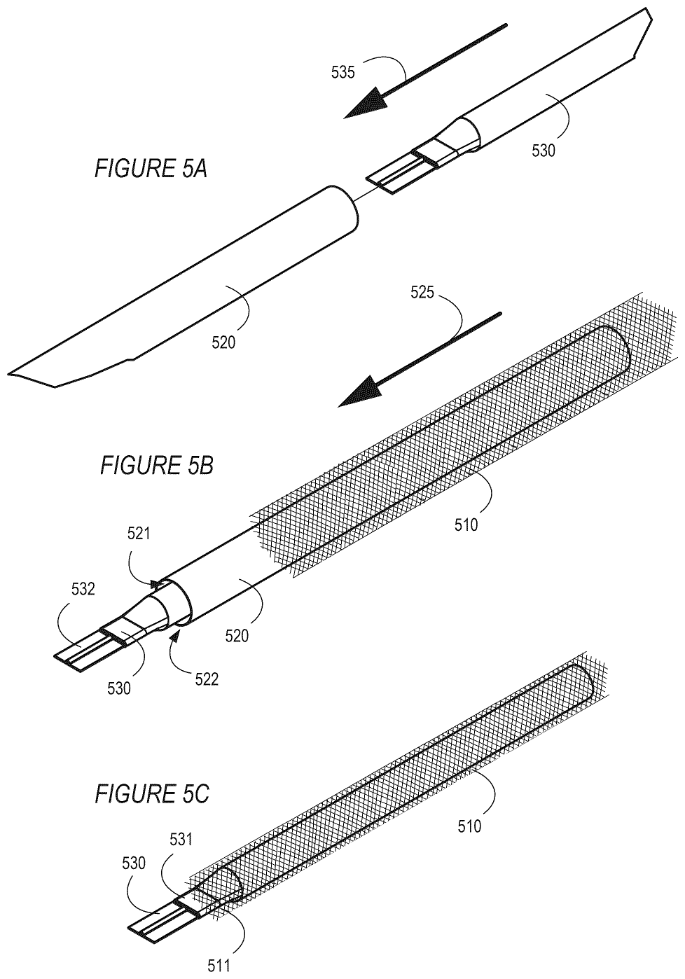

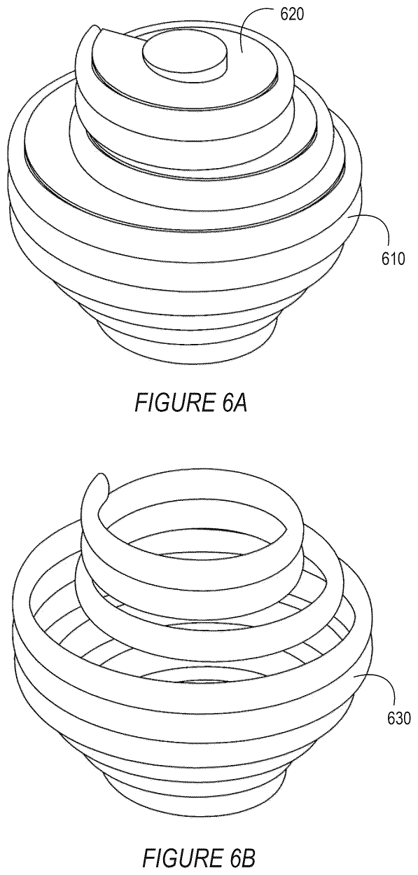

As shown in FIGS. 2A through 4B, it is common for FPAMs to be provided initially which are generally rectilinear in shape. One method of making a rectilinear FPAM is illustrated in FIGS. 5A through 5C. As shown in FIG. 5B, a sheath 510, having substantially a tubular mesh structure, may be slid or otherwise positioned enveloping a forming tube 520, which may be a rigid or semi-rigid tube, as illustrated by arrow 525. Either beforehand or afterward, as shown in FIG. 5A, a bladder 530 may be positioned and extended longitudinally within a hollow 521 of the forming tube 520 as illustrated by arrow 535. This arrangement is shown in FIG. 5A. FPAM bladders disclosed herein may be made using any manufacturing techniques, including but not limited to extrusion, molding, sheet rolling, and/or dipping, and may be formed of any suitable material, which may be an elastomeric material. The forming tube 520 may function to prevent, minimize, or reduce contact between the sheath 510 and the bladder 530 until the sheath 510 is positioned in a predetermined manner relative to the bladder 530, which may include a position where it encircles the entire bladder 530. Then, corresponding proximal ends 511,531 of the sheath 510 and bladder 530 at an open end 522 of the forming tube 520 may be pulled together away from the open end 522, thereby causing the sheath 510 to contact and envelop the bladder 530 progressively along their respective lengths as they are together drawn further from the the forming tube 520. Eventually, the sheath 510 and the bladder 530 may be drawn completely from the forming tube 520, providing an FPAM formed from the sheath 510 and bladder 530 as shown in FIG. 5C, and as substantially as described and shown in the different embodiments herein. While the bladder 530 in FIGS. 5A through 5C is shown as having a constriction 532 (discussed further below), it will be understood that an FPAM may be assembled as described above using bladders without constrictions.

The foregoing method may prevent or at least reduce the bladder from becoming stretched, twisted, deformed, and/or damaged during the sheathing process. Stretching the bladder during sheathing may be detrimental as it may place stress on any joints in the bladder. Sheathing without use of the forming tube may also risk ripping or tearing the bladder wall. In some embodiments, the forming tube may be sufficiently smooth so as to reduce or optimally minimize friction between the bladder and forming tube as well as friction between the sheath and the forming tube. A wet or dry lubricant may optionally be applied to an outside surface of the bladder to facilitate insertion of the bladder into the forming tube, and may further reduce the likelihood of a tear or other damage to the bladder wall.

With reference to FIGS. 6A & 6B, in order to provide an FPAM having a generally circular or helical shape as described herein—or alternatively any other specified shape—and I in accordance with method 1500, a precursor FPAM 610, originally having a generally rectilinear shape, can be wrapped around a mandrel 620 having the desired shape, as shown in FIG. 6A (step 1510). The assembly can then be treated in a predetermined manner to generate a treated FPAM 630 having the desired shape (step 1520). For example, the assembly of the precursor FPAM 610 and the mandrel 620 may be heated in an oven at a predetermined temperature for a predetermined period. For example, the assembly may be held at the predetermined temperature for from about 1 to about 24 hours. The assembly may then be cooled, either by simply removing the assembly to ambient temperature, or by quenching in a quenching medium at a predetermined cooling temperature. The quenching medium may be a liquid, and following quenching the FPAM may be dried before removal from the mandrel. Alternatively, the precursor FPAM 610 can be maintained on the mandrel 620 at ambient temperature for an extended period of time, for example from about 1 week to about 2 years. The desired and effective duration of treatment may be dependent on the sheath material, and may also be dependent on the bladder material and thickness. Following treatment, the treated FPAM 630 may be removed from the mandrel 620 (step 1530), and the treated FPAM 630 may retain substantially the shape of the mandrel 620, as shown in FIG. 6B. The treated FPAM 630 may be resilient, in that it may deform under pressurization as described herein, while substantially rebounding to its original circular or helical, or other desired, shape when such pressurization is relaxed.

The foregoing method may be enabled, facilitate, or rendered especially advantageous when the FPAM sheath is formed of a thermoplastic material. In such case, the predetermined treatment temperature may be within about 20° C. of the glass transition temperature of the thermoplastic material. When the sheath is formed of non-thermoplastic materials, the predetermined treatment temperature may be selected based on a property of such material which may include a material-specific transition temperature such as the recrystallization temperature for metals.

### Basic FPAM Function

In all embodiments of the compression therapy device, the one or more compression actuators are operable to selectively apply compression to a body part. In particular, the FPAM or FPAMs, as the case may be, may be selectively inflated to apply compression and deflated to relax compression. While the FPAMs described herein have a circular or helical shape, their mode of operation may be substantially similar to, and may be more easily visualized with, an FPAM having a substantially coiled or ring-shaped structure, which is now described.

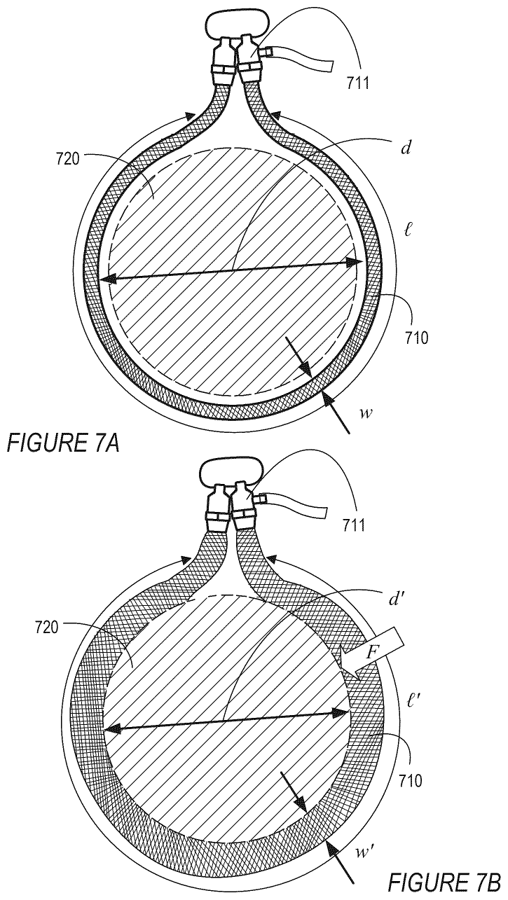

Thus, with reference to FIGS. 7A & 7B, a coiled/ring-shaped FPAM 710 may generate compression force F on an object 720 when the FPAM 710 is inflated as described herein. This compression force arises as the FPAM 710 length [symbol] shortens to [symbol] ′, resulting from its inflation, which causes a diameter d of the ring to decrease to d′ when the ends 711 of the FPAM 710 are fixed and/or constrained. For example, an FPAM, including a compression actuator containing the FPAM, may be provided in a compression garment, where ends of the FPAM are fixed at respective locations in the compression garment. Other arrangements are possible and contemplated. When the ends 711 are fixed and/or constrained, all or most of the FPAM 710 contraction may result in reduction of the diameter from d to d′. If the ends are entirely free to move and/or are unconstrained, then the diameter d might remain unchanged as the ends 711 would shift to account for the contraction. Any combination of constrained and unconstrained ends and/or constraints along the length [symbol] may result in a combination of the ends moving and the diameter d shrinking. Additionally, expansion of a cross-sectional width w of the FPAM 710 to w′ may apply further compression force F on the object 720 it is wrapped around. Any functional variations and combinations of such arrangements are possible and contemplated, and in general may be selected depending on the particular applications involved.

### Example Compression Therapy Devices

The following are non-limiting examples of embodiments of compression therapy devices.

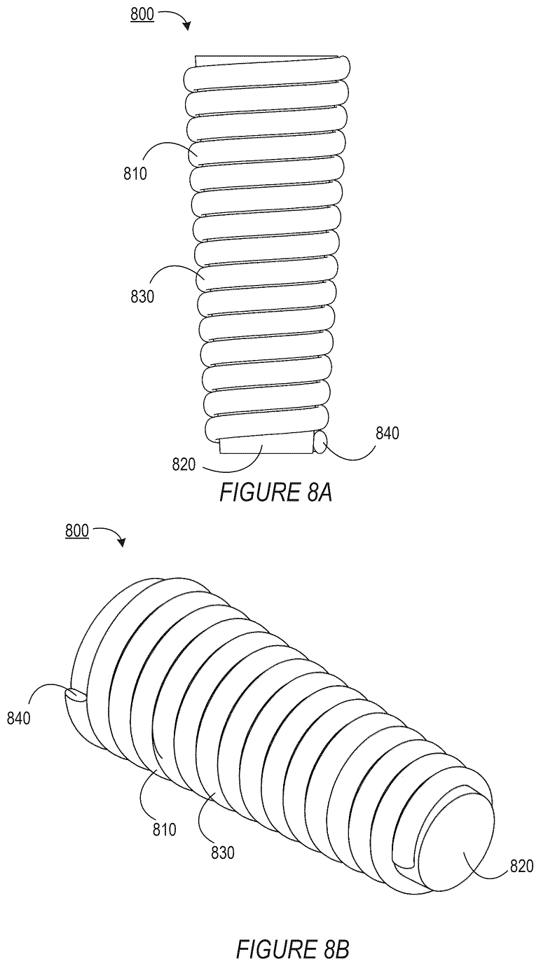

One compression therapy device 800 is shown in FIGS. 8A & 8B. The compression therapy device 800 has a compression actuator 810 shown enveloping a body part 820. The compression actuator 810 includes an FPAM 830 which has a helical shape and is resilient. Although the compression actuator 810 is shown to include a single FPAM 830, in other embodiments it may include a set of multiple FPAMs fluidly coupled in sequence. Embodiments of the compression actuator 810 (or the set of multiple FPAMs, as the case may be) may have any desired size, shape, and configuration, so long as the shape is generally helical. In the embodiment shown, the body part 820 is a forearm, although other body parts are possible and contemplated. Thus, for different embodiments of the compression therapy device 800, the compression actuator 810 may have a size, shape, and configuration matching the body part 820 for with which use of the compression therapy device 800 is intended. As described above, ends 831 of the FPAM 830 may be substantially fixed in location, and as such, selective inflation of the FPAM 830 may generate compression of the forearm 820 by the FPAM 830, and selective deflation of the FPAM 830 may relax such compression.

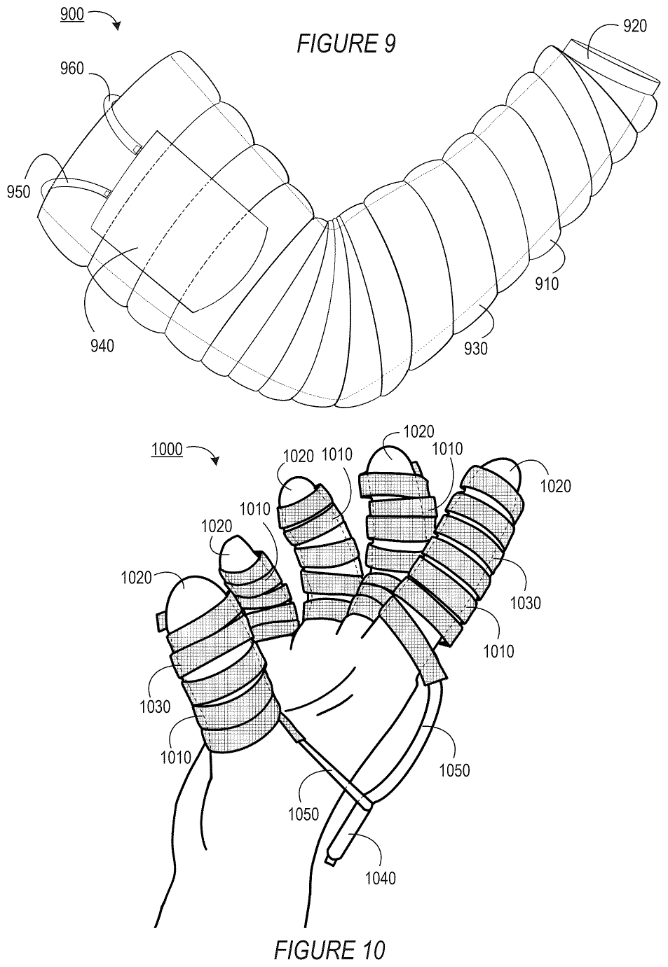

Another embodiment of a compression therapy device 900 is shown in FIG. 9. The compression therapy device 900 has a compression actuator 910 shown enveloping a body part 920. The compression actuator 910 includes an FPAM 930 which has a helical shape and is resilient. Although the compression actuator 910 is shown to include a single FPAM 930, in other embodiments it may include a set of multiple FPAMs fluidly coupled in sequence. Embodiments of the compression actuator 910 (or the set of multiple FPAMs, as the case may be) may have any desired size, shape, and configuration, so long as the shape is generally helical. In the embodiment shown, the body part 920 is an arm, although other body parts are possible and contemplated. The compression therapy device 900 further has a control system 940, and an inlet tube 950 and an outlet tube 960 each fluidly coupled with the control system 940. Each of the inlet tube 950 and the outlet tube 960 may constitute a connector.

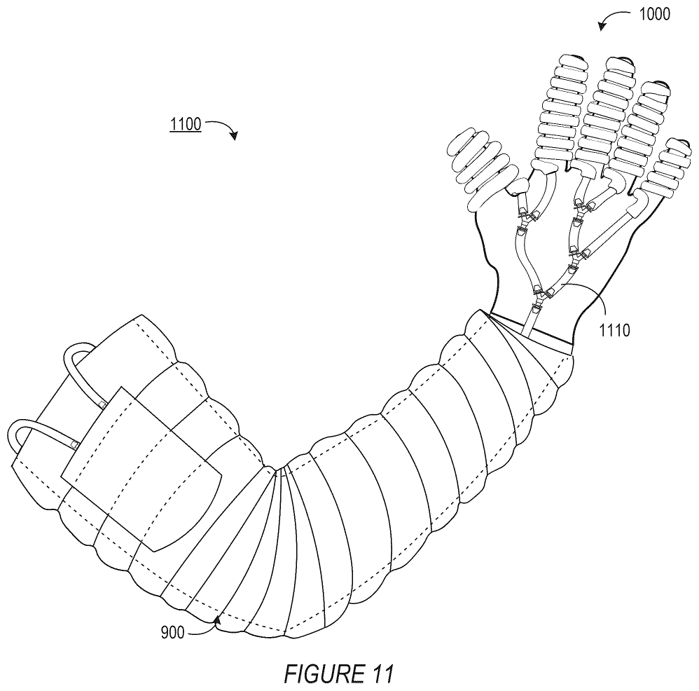

Another compression therapy device 1000 is shown in FIG. 10. The compression therapy device 1000 has a plurality of compression actuators 1010 shown enveloping respective body parts 1020. Each compression actuator 1010 includes an FPAM 1030 which has a helical shape and is resilient. Although the compression actuators 1010 are shown respectively to include single FPAMs 1030, in other embodiments one of more of them may include a set of multiple FPAMs fluidly coupled in sequence. Embodiments of the compression actuators 1010 (or the set of multiple FPAMs, as the case may be) may have any desired size, shape, and configuration, so long as the shape is generally helical. In the embodiment shown, the body parts 1020 are digits (four fingers and a thumb of a hand), although other body parts are possible and contemplated. The compression therapy device 1000 further has an inlet/outlet tube 1040 and branch tubes 1050, each of which may constitute a connector, fluidly connected with the compression actuators 1010. As shown, the branch tubes 1050 are connected with the compression actuators 1010 corresponding to the thumb and index finger of the hand. The remaining compression actuators 1010 (those corresponding to the other fingers of the hand) may be connected with the inlet/outlet tube 1040, and thus the source of pressurized fluid (such as a pump) in any suitable way. For example, the compression actuators 1010 may be fluidly connected in series using further tubes (not shown), which may constitute further connectors. Alternatively, the compression actuators 1010 may be separately fluidly connected to a manifold (not shown), which is then fluidly connected to the inlet/outlet tube 1040, and therefore the source of pressurized fluid. All suitable and operable alternatives are possible and contemplated.

Another compression therapy device 1100 is shown in FIG. 11. The compression therapy device 1100 is substantially a combination of the compression therapy device 900 shown in FIG. 9, having a compression actuator 910 enveloping a body part 920 which is an arm of a user, and the compression therapy device 1000 shown in FIG. 10 having a plurality of compression actuators 1010 shown enveloping respective body parts 1020 which are the digits of a hand of the user. (The reference characters and lead lines shown in FIGS. 9 & 10 apply mutatis mutandis to the compression therapy device 900 and compression therapy device 1000 shown in FIG. 11.) The compression therapy device 1100 has additional tubes/connectors 1110 which fluidly couple the compression therapy device 900 and compression therapy device 1000.

### Continuous and Composite FPAMs

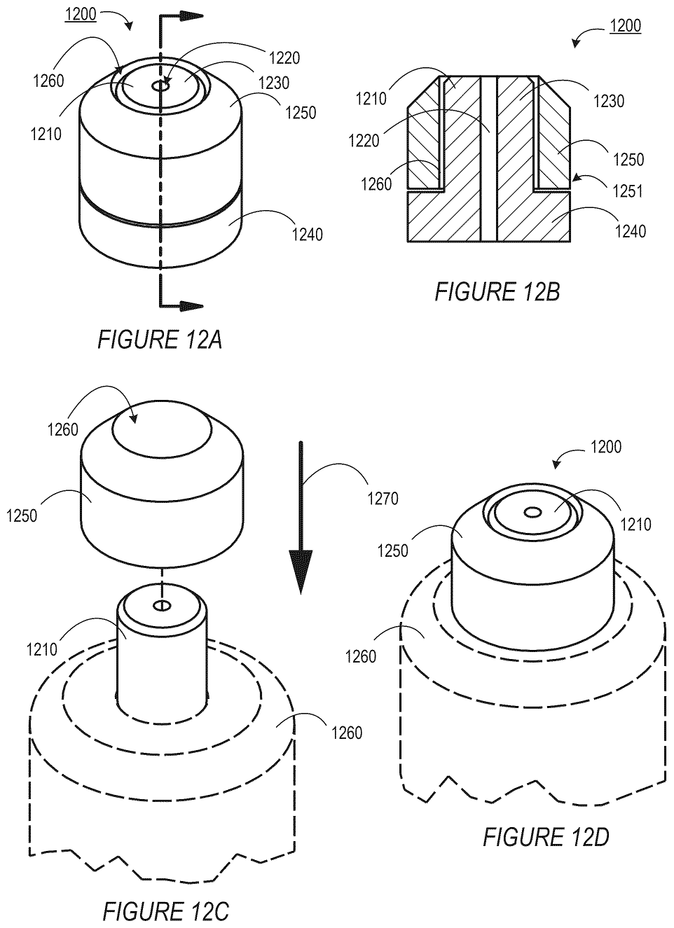

In general, an FPAM referenced herein may have a single continuous bladder or a composite bladder formed of a plurality of bladder segments joined together. The segments may be joined through mechanical, chemical, and/or any other means and/or any combination thereof. The FPAMs disclosed herein may have any desired length, which in different embodiments may be from about 1 mm to about 100 m. In particular, in some embodiments the FPAM may include microfluidic constrictions incorporated into the bladder or adjoining bladder segments so as to enable sequential inflation of portions of the bladder. Such constrictions may be formed by partially blocking the bladder with external components, internal components, and/or by selectively fusing the bladder to itself so as to reduce a cross-sectional area available for fluid flow. FIGS. 12A through 14B show examples of devices and methods for providing constrictions in an FPAM bladder.

Thus, FIGS. 12A through 12D show a two-part constriction device 1200 including a nozzle 1210 defining a nozzle channel 1220, a nozzle post 1230, and a nozzle shoulder 1240, a collar 1250, and a collar channel 1260 sized as shaped to slidingly and fittingly receive and slide onto the nozzle post 1230 so as to abut a bottom end 1251 of the collar 1250 with the nozzle shoulder 1240. As shown in FIG. 12C, a bladder 1260 may be coupled with and envelop the nozzle shoulder 1240 such that when the collar 1250 is slid onto the nozzle post 1230 as described and illustrated by arrow 1270, the coupling of the nozzle 1210 and collar 1250 may maintain coupling of or resist decoupling of the bladder 1260 and nozzle 1210. The nozzle channel 1220 may have a transverse cross-sectional area which is less than a corresponding cross-sectional area of the bladder 1260, such that the nozzle 1210 may function as a constriction.

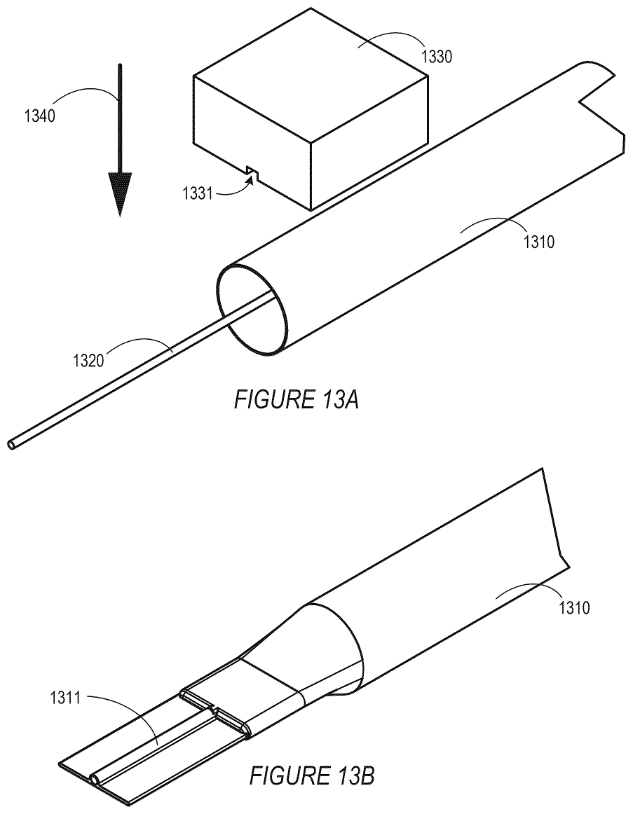

Another technique for providing a constriction is a single bladder is by a crimping or forming method. An example crimping or forming procedure is illustrated in FIGS. 13A through 13B. A bladder 1310 is provided and a rigid die, such as a wire 1320, is positioned with the bladder 1310. Then, a crimping head 1330 or other forming or crimping device, which may have a die form 1331, which may be a groove, sized and shaped based on a size and shape of the wire 1320 or other rigid die, is used to press or crimping the assembly of the bladder 1310 and wire 1320 with alignment of the wire 1320 and die form 1331, as illustrated by arrow 1340. The assembly of the bladder 1310, the wire 1320, and the crimping head 1330 may then be treated, while maintaining crimping pressure, which may include heat treatment at a predetermined treatment temperature, maintenance for a predetermined period of time, or both. Following treatment, when the crimping head 1330 and die form 1320 are removed, the bladder 1310 may retain an impression of the wire 1320 or other rigid die, and the die form 1331, which in this example is a constriction channel 1311, which may function as a constriction as described herein.

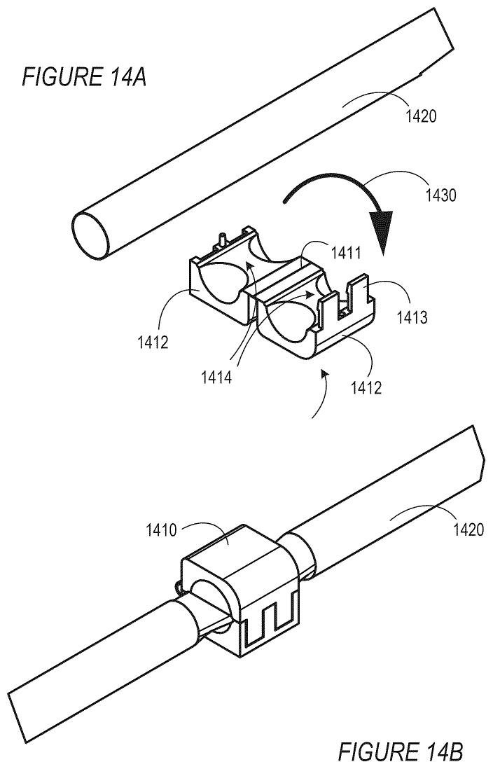

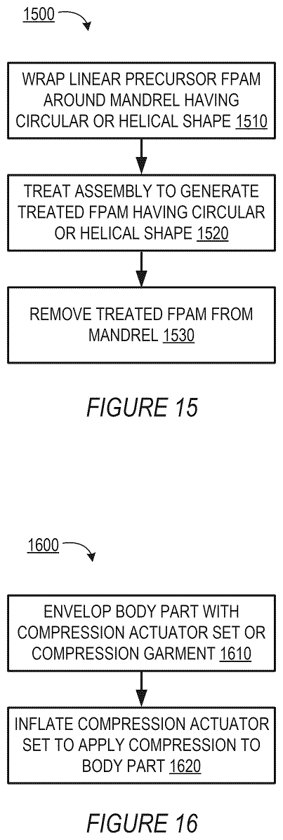

A yet further technique for providing a constriction is the use of a constriction device which remains in-place on a bladder while operation of the constriction is desired, and which may be removed when operation of the constriction is no longer desired. Such a constriction device 1410 is illustrated in FIGS. 14A through 14B. The constriction device 1410 may have a generally clamshell configuration, having hinge 1411 at one side joining two clamshell halves 1412, and retention tabs 1413 at an opposite side for selectively retaining the clamshell halves 1412 in a closed state. The clamshell halves 1412 may form cooperating molding cavities 1414 which, when the clamshell halves 1412 are in the closed state (shown in FIG. 14B), together form between them a constriction channel. A bladder 1420 may be placed between the clamshell halves 1412, which may then be closed as described to clamp the bladder 1420 within the clamshell halves 1412 molding cavities 1414, illustrated by arrow 1430, and the constriction channel thus defined (not shown), as shown in FIG. 14B, may form a constriction in the bladder 1420, with the retention tabs 1413 engaging to retain the constriction device 1410 in the closed state. The retention tabs 1413 may selectively be disengaged to open the constriction device 1410 to remove the bladder 1420 and likewise the constriction therefrom.

A composite bladder formed as described herein may either be so formed such that the bladder segments are permanently joined together, or are instead removable. In the latter case, the bladder segments and coupling means for coupling them together may be used to selectively form a composite bladder of any desired length of the resulting FPAM for use in a corresponding particular application.

In general, constrictions provided in a single bladder or composite bladder may function to provide predetermined different fluid flow resistances in each direction of flow such that the portions of the single bladder or the plurality of bladders, respectively, may be inflated and/or deflated at differing rates. Such functionality may be further achieved through the insertion of valves and/or separated fluid constriction channels for each direction of fluid flow.

### Uses and Advantages

The compression therapy systems and compression therapy devices disclosed herein may be useful in at least some therapeutic applications involving the application of controlled mechanical pressure to body parts. Such applications may include the treatment of circulatory disorders such as lymphedema, deep vein thrombosis (DVT), and venous leg ulcers. They may also include massage therapy, post-surgery recovery treatment, pre-activity preparation for physical activity, and post-activity muscle recovery for sports or other physical activity.

The compression therapy devices disclosed herein may be incorporated into or form a part of a garment, such as a compression therapy garment or apparel, which in different embodiments may further include other components and functionalities, such as heating and/or cooling functionality, vibration devices, electrical stimulation devices, and/or light stimulation devices.

Embodiments of the subject-matter disclosed herein may also be useful for applications in the field of soft robotic devices more generally. For example, a compression actuator as described herein may function as a robotic gripper, operable to selective grip objects through the applicable of pressure as described herein.

Embodiments of the disclosed subject-matter may provide advantages over known solutions. As compared to prior compression actuators employing a generic bladder, the compression actuators disclosed herein may provide or provide an improved constriction force. The disclosed compression actuators employing a closed ring or helix may apply compression uniformly around a limb or other body part. Prior solutions may have required additional components, such as a belt, substrate, or other connective fabric to transmit the constrictive force of an FPAM to a limb or body part, while the disclosed compression actuators may function to do so without the need of, or the need of as much or as many of, such additional components, thereby saving on cost, materials, and complication of manufacture.

### EXAMPLE EMBODIMENTS

The following are non-limiting example embodiments of the subject-matter disclosed herein.

Embodiment 1. A compression actuator comprising a fluid-powered artificial muscle (FPAM) set of at least one FPAM, wherein the compression actuator has a circular or helical shape and is resilient.

Embodiment 2. The compression actuator of Embodiment 1, wherein: each FPAM of the FPAM set comprises a bladder having a wall and a sheath, wherein the sheath comprises sheath fibers woven in a double helix formation.

Embodiment 3. The compression actuator of Embodiment 2, wherein: the sheath envelops the bladder.

Embodiment 4. The compression actuator of Embodiment 2, wherein: the sheath is embedded within the wall of the bladder.

Embodiment 5. The compression actuator of any one of Embodiments 1 to 4, wherein: the compression actuator has the helical shape.

Embodiment 6. The compression actuator of any one of Embodiments 1 to 5, wherein: for at least one FPAM of the FPAM set, a thickness of the wall of the bladder varies along a longitudinal axis of the bladder.

Embodiment 7. The compression actuator of any one of Embodiments 1 to 6, wherein: for at least one FPAM of the FPAM set, an elasticity of the wall of the bladder varies along a longitudinal axis of the bladder.

Embodiment 8. The compression actuator of any one of Embodiments 1 to 7, wherein: the FPAM set comprises a plurality of FPAMs fluidly coupled in sequence; and the compression actuator further comprises at least one connector fluidly coupling corresponding adjacent FPAMs in the FPAM set.

Embodiment 9. The compression actuator of Embodiment 8, wherein: at least one of the at least one connector comprises a constriction device operable to constrict a flow of the fluid therethrough.

Embodiment 10. The compression actuator of any one of Embodiments 1 to 9, wherein: at least one FPAM of the FPAM set is a segmented FPAM; the bladder of the segmented FPAM comprises at least one constriction between corresponding adjacent bladder segments of the bladder; and the at least one constriction constricts fluid flow between the adjacent bladder segments.

Embodiment 11. A compression therapy device comprising: a compression actuator set comprising at least one compression actuator as defined by any one of Embodiments 1 to 10; an inlet connector coupled with the compression actuator set for inflating the compression actuator set with a pressurized fluid.

Embodiment 12. The compression therapy device of Embodiment 11, further comprising: a pump coupled with the inlet connector and operable to inflate the compression actuator set with the pressurized fluid.

Embodiment 13. The compression therapy device of Embodiment 12, further comprising: a control system fluidly coupled with the compression actuator set to selectively inflate or deflate the compression actuator set.

Embodiment 14. The compression therapy device of Embodiment 13, wherein: the control system comprises the pump, and further comprises a controller operable to selectively operate the pump.

Embodiment 15. A compression garment comprising the compression therapy device of any one of Embodiments 11 to 14 and at least one garment fabric coupled with the compression therapy device.

Embodiment 16. The compression garment of Embodiment 15, wherein: the compression garment is a sleeve or glove.

Embodiment 17. A compression therapy method comprising: enveloping a body part of a patient with the compression actuator set of the compression therapy device of any one of Embodiments 11 to 14 or the compression garment of Embodiment 15 or 16; and inflating the compression actuator set to apply compression to the body part.

Embodiment 18. A method for making an FPAM having a circular or helical shape, the method comprising: wrapping a precursor FPAM having a linear shape around a mandrel having the circular or helical shape to form an assembly; treating the assembly to generate a treated FPAM having the circular or helical shape; and removing the treated FPAM from the mandrel.

Embodiment 19. The method of Embodiment 18, wherein: treating the assembly comprises heating the assembly at a predetermined elevated temperature for a predetermined period.

Embodiment 20. The method of Embodiment 19, wherein: the FPAM comprises a bladder and a sheath; the sheath is formed of a thermoplastic material; and the predetermined elevated temperature is within about 20° C. of a glass transition temperature of the thermoplastic material.

### Interpretation

So that the present disclosure may be more readily understood, certain terms are defined. Unless defined otherwise, all technical and scientific terms used herein have the same meaning as commonly understood by one of ordinary skill in the art to which embodiments of the invention pertain. While many methods and materials similar, modified, or equivalent to those described herein can be used in the practice of the embodiments of the present invention without undue experimentation, the preferred materials and methods are described herein.

All terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 1½, and 4¾. This applies regardless of the breadth of the range.

The terms “about” or “approximately” as used herein refer to variation in the numerical quantity that can occur, for example, through typical measuring techniques and equipment, with respect to any quantifiable variable, including, but not limited to, mass, volume, time, distance, voltage, and current. Further, given solid and liquid handling procedures used in the real world, there is certain inadvertent error and variation that is likely through differences in the manufacture, source, or purity of the ingredients used to make the compositions or carry out the methods and the like. The terms “about” and “approximately” also encompass these variations. Expressions which combine the terms “about” or “approximately” with one or more bounds of a range refer to a union of the bound modified by the term “about” or “approximately” as described above, and the range having the unmodified bound. Thus, for example, the expression “at least about X” means the union of “at least X” and “about X”. Similarly, “at most about Y” means the union of “at most Y” and “about Y”.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”. “Consisting essentially of”, when used in the claims, shall have its ordinary meaning as used in the field of patent law.

Embodiments of the disclosed subject-matter are described herein using the auxiliary verb “may”. When used herein, unless required otherwise by the context of usage, the auxiliary verb “may” designates an embodiment of the disclosed subject-matter which possesses the addressed object without requiring necessarily that any other embodiment of the disclosed subject-matter possesses the addressed object. Thus, a statement such as “X may include Y” indicates that the disclosed subject-matter includes embodiments where X includes Y, without requiring that all disclosed embodiments include Y, and without excluding any other embodiments which do not include Y.

While the disclosed subject-matter may be embodied in many different forms, there are described in detail herein specific embodiments. The present disclosure is an exemplification of the principles of the disclosed subject-matter and is not intended to limit the disclosed subject-matter to the particular embodiments illustrated. Furthermore, the disclosed subject-matter encompasses any possible combination of some or all of the various embodiments mentioned herein. In addition the disclosed subject-matter encompasses any possible combination that also specifically excludes any one or some of the various embodiments mentioned herein.

Different embodiments disclosed herein, including particularly the controller 110, may include any computing and related information technology useful to perform the functions described herein. Such technology may include one or more computers, one or more servers, a group or groups of multiple servers, or one or mobile computing devices. Each of these may include or use further processing or communications technologies, which may include any number of processors and processor types, such as CPUs, one or more graphics processing units (GPUs), digital signal processors (DSPs), and so forth. In general, each such processor is operable to execute or perform instructions stored in a memory. Such memory may include or interface persistent memories, such as storage. Each such processor may use any communications technology which may include network interface controllers (NICs), which may be wired or wireless controllers, operable to perform communication over a network, which may be or include the Internet. Different embodiments may include or be implemented in part or in whole in a cloud computing environment, including without limitation Amazon AWS™ or Microsoft Azure™.

In some instances, well-known hardware and software components, modules, and functions are shown in block diagram form in order not to obscure the invention. For example, specific details are not provided as to whether the embodiments described herein are implemented as a software routine, hardware circuit, firmware, or a combination thereof.

Some of the embodiments described herein include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory.

Embodiments can be implemented as a software product stored in a machine-readable medium (also referred to as a computer-readable medium, a processor-readable medium, or a computer usable medium having a computer-readable program code embodied therein), which may be non-transient. The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks.

In the preceding description, for purposes of explanation, numerous details are set forth in order to provide a thorough understanding of the embodiments. However, it will be apparent to one skilled in the art that these specific details are not required. In particular, it will be appreciated that the various additional features shown in the drawings are generally optional unless specifically identified herein as required. The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A compression actuator comprising a fluid-powered artificial muscle (FPAM) set of at least one FPAM, wherein the compression actuator has a circular or helical shape and is resilient.

2. The compression actuator of claim 1, wherein:
each FPAM of the FPAM set comprises a bladder having a wall and a sheath, wherein the sheath comprises sheath fibers woven in a double helix formation.

3. The compression actuator of claim 2, wherein:
the sheath envelops the bladder.

4. The compression actuator of claim 2, wherein:
the sheath is embedded within the wall of the bladder.

5. The compression actuator of claim 1, wherein:
the compression actuator has the helical shape.

6. The compression actuator of claim 1, wherein:
for at least one FPAM of the FPAM set, a thickness of the wall of the bladder varies along a longitudinal axis of the bladder.

7. The compression actuator of claim 1, wherein:
for at least one FPAM of the FPAM set, an elasticity of the wall of the bladder varies along a longitudinal axis of the bladder.

8. The compression actuator of claim 1, wherein:
the FPAM set comprises a plurality of FPAMs fluidly coupled in sequence; and
the compression actuator further comprises at least one connector fluidly coupling corresponding adjacent FPAMs in the FPAM set.

9. The compression actuator of claim 8, wherein:
at least one of the at least one connector comprises a constriction device operable to constrict a flow of the fluid therethrough.

10. The compression actuator of claim 1, wherein:
at least one FPAM of the FPAM set is a segmented FPAM;
the bladder of the segmented FPAM comprises at least one constriction between corresponding adjacent bladder segments of the bladder; and
the at least one constriction constricts fluid flow between the adjacent bladder segments.

11. A compression therapy device comprising:
a compression actuator set comprising at least one compression actuator as defined by claim 1;
an inlet connector coupled with the compression actuator set for inflating the compression actuator set with a pressurized fluid.

12. The compression therapy device of claim 11, further comprising:
a pump coupled with the inlet connector and operable to inflate the compression actuator set with the pressurized fluid.

13. The compression therapy device of claim 12, further comprising:
a control system fluidly coupled with the compression actuator set to selectively inflate or deflate the compression actuator set.

14. The compression therapy device of claim 13, wherein:
the control system comprises the pump, and further comprises a controller operable to selectively operate the pump.

15. A compression garment comprising the compression therapy device of claim 11 and at least one garment fabric coupled with the compression therapy device.

16. The compression garment of claim 15, wherein:
the compression garment is a sleeve or glove.

17. A compression therapy method comprising:
enveloping a body part of a patient with the compression actuator set of the compression therapy device of claim 11; and
inflating the compression actuator set to apply compression to the body part.

18. A method for making an FPAM having a circular or helical shape, the method comprising:
wrapping a precursor FPAM having a linear shape around a mandrel having the circular or helical shape to form an assembly;
treating the assembly to generate a treated FPAM having the circular or helical shape; and
removing the treated FPAM from the mandrel.

19. The method of claim 18, wherein:
treating the assembly comprises heating the assembly at a predetermined elevated temperature for a predetermined period.

20. The method of claim 19, wherein:
the FPAM comprises a bladder and a sheath;
the sheath is formed of a thermoplastic material; and
the predetermined elevated temperature is within about 20° C. of a glass transition temperature of the thermoplastic material.
